(19) United States
(12) Patent Application Publication
(10) Pub. No.: US 2024/0102504 A1
(43) Pub. Date: Mar. 28, 2024

(54) Threaded fastener

(71) Applicant: Wen-Pin Huang, Kaohsiung (TW)

(72) Inventor: Wen-Pin Huang, Kaohsiung (TW)

(21) Appl. No.: 18/386,247

(22) Filed: Nov. 1, 2023

(51) Int. Cl. F16B 33/02; F16B 37/00

(52) U.S. Cl. CPC F16B 33/02; F16B 37/00

(57) ABSTRACT

A fastener includes a bolt including a head and a threaded shank including a bare section proximate the head, a threaded end section, an intermediate section proximate the threaded end section and having a spiral trough, and a threaded section between the intermediate section and the bare section; and a hollow member including a head member and a malleable shank. The malleable shank has first, second and third holes.

### BACKGROUND OF THE INVENTION

### 1. Field of the Invention

The invention relates to fasteners and more particularly to a threaded fastener having improved characteristics including an increased fastening force.

### 2. Description of Related Art

Referring to FIG. 1, a bolt 10′ of a conventional threaded fastener is shown and referring to FIG. 2, an elongated, hollow member 11′ of the conventional threaded fastener is shown. The bolt 10′ comprises an enlarged head 100′ and a threaded shank 101′ having an intermediate bare section 102′.

However, the conventional threaded fastener is disadvantageous because the fastening force exerted on a work piece by the threaded fastener is not sufficient. It is typical that the work piece may be loosened.

Thus, the need for improvement still exists.

### SUMMARY OF THE INVENTION

It is therefore one object of the invention to provide a fastener comprising a bolt including a head and a threaded shank including a bare section proximate the head, a threaded end section, an intermediate section proximate the threaded end section and having a spiral trough, and a threaded section between the intermediate section and the bare section; and a hollow member including a head member and a malleable shank having a plurality of holes.

The invention has the following advantages and benefits in comparison with the conventional art: a fastening force is increased. The manufacturing cost is decreased. Length of the bolt is decreased. A variety of work pieces having different thickness can be fastened.

The above and other objects, features and advantages of the invention will become apparent from the following detailed description taken with the accompanying drawings.

### BRIEF DESCRIPTION OF THE DRAWINGS

FIG. 1 is a side elevation of a bolt of a conventional threaded fastener;

FIG. 2 is a sectional view of a hollow member of the conventional threaded fastener;

FIG. 3 is a perspective view of a bolt of a threaded fastener according to the invention;

FIG. 4 is a side elevation of the bolt in FIG. 3;

FIG. 5 is a partially broken away view of a hollow member of the threaded fastener according to the invention;

FIG. 6 is a side elevation of the hollow member in FIG. 5;

FIG. 7 is a perspective view of a work piece;

FIG. 7A is another perspective view of the work piece;

FIG. 8 schematically depicts the bolt and the hollow member of the invention to be assembled;

FIG. 9 is a partially broken away view of the bolt and the hollow member of the invention being assembled;

FIG. 10 is a partially broken away view showing the work piece in a step of being fastened by the bolt and the hollow member of the invention;

FIG. 11 is a longitudinal sectional view of the work piece positioned by the bolt and the hollow member of the invention;

FIG. 12 is a view similar to FIG. 11 showing the malleable shank of the hollow member being pressed to fasten the work piece; and

FIG. 13 is a partially broken away view showing the work piece being fastened by the bolt and the hollow member of the invention.

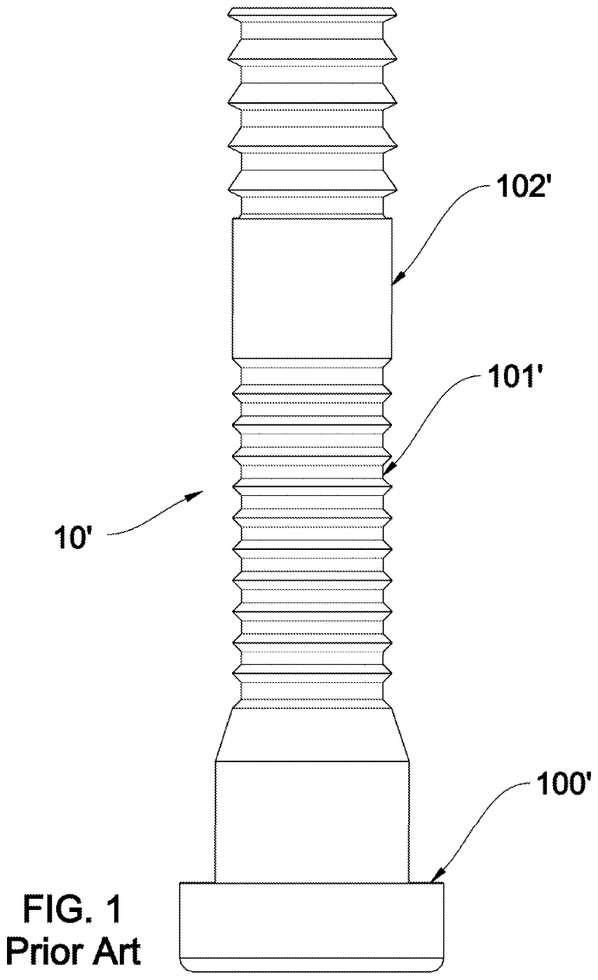

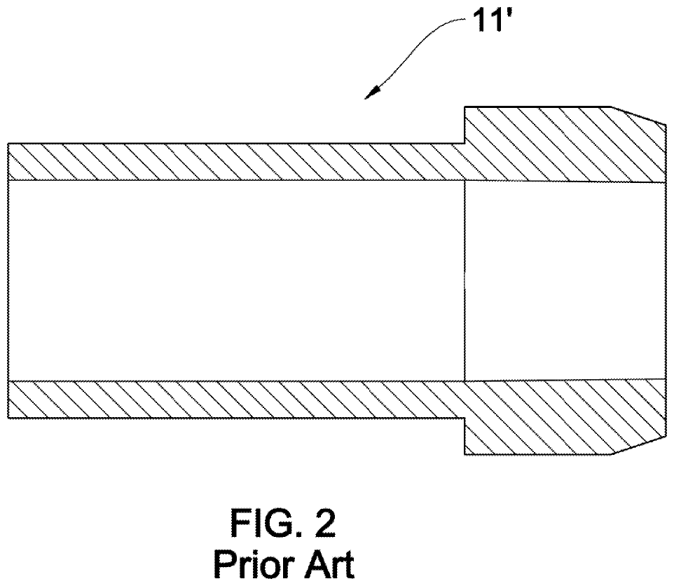

### DETAILED DESCRIPTION OF THE INVENTION

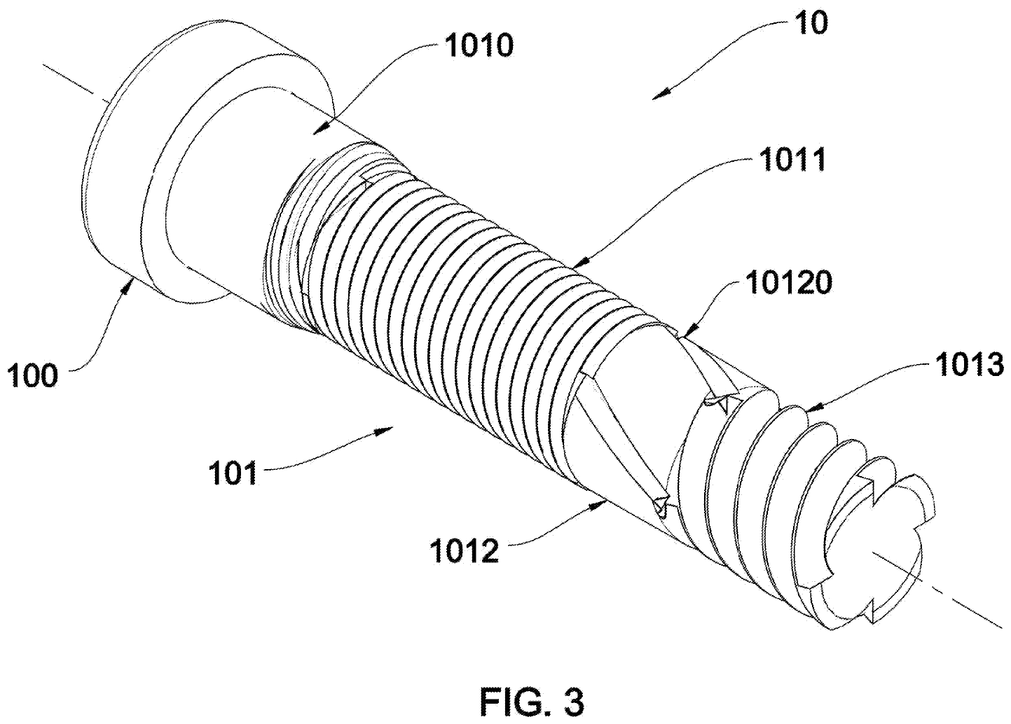

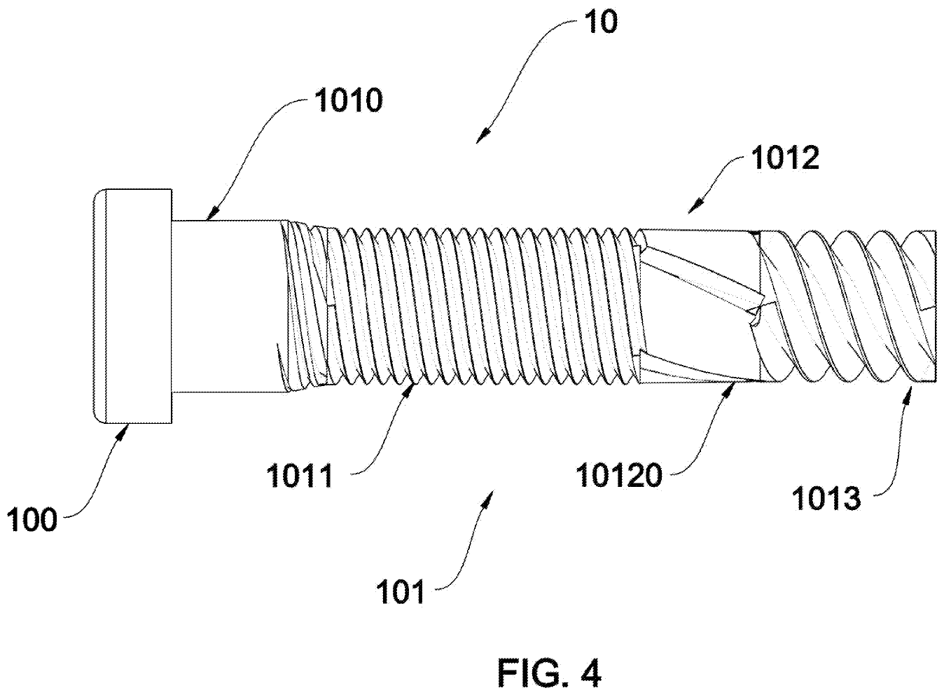

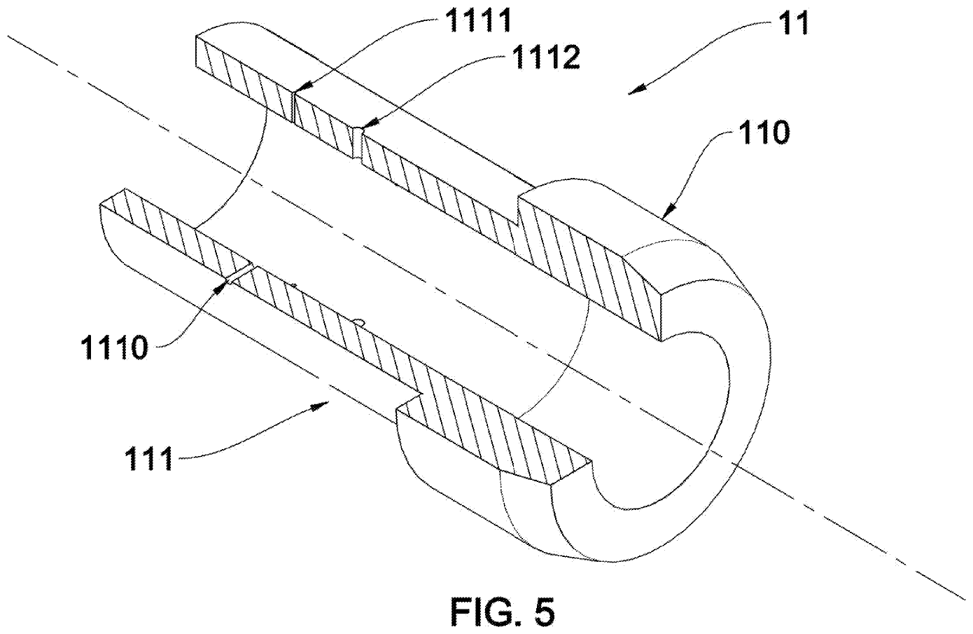

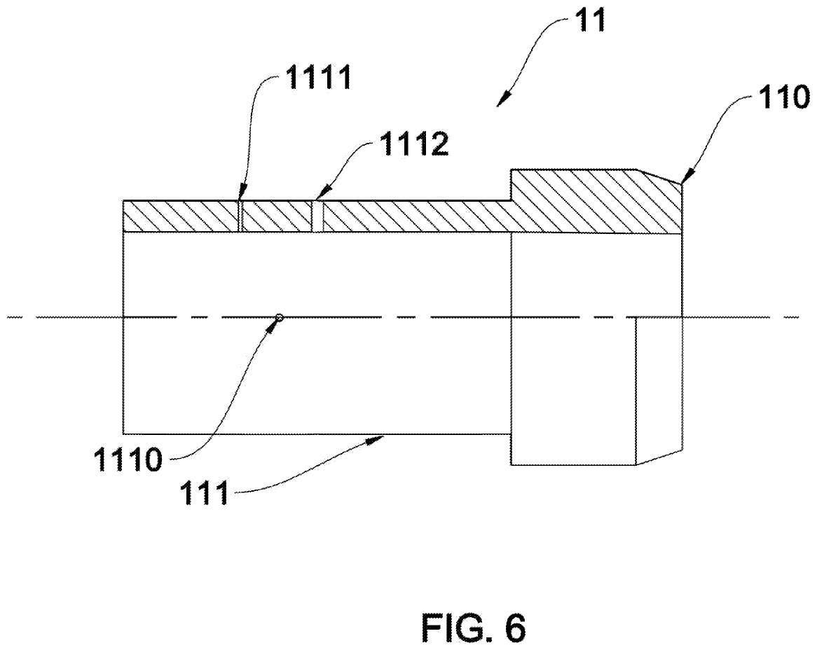

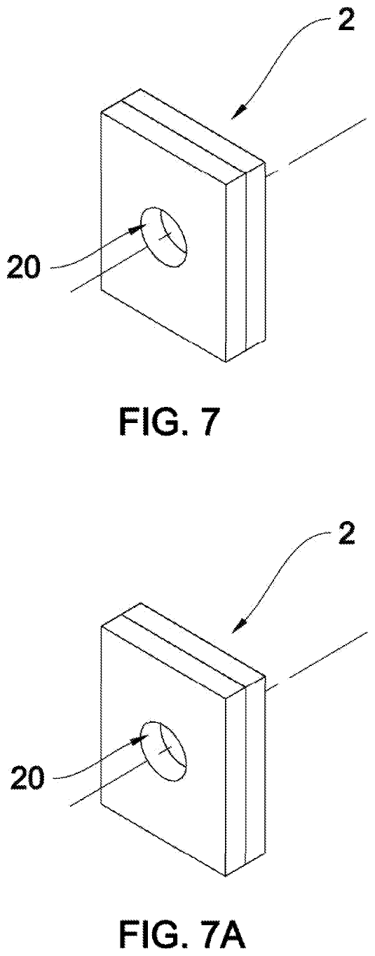

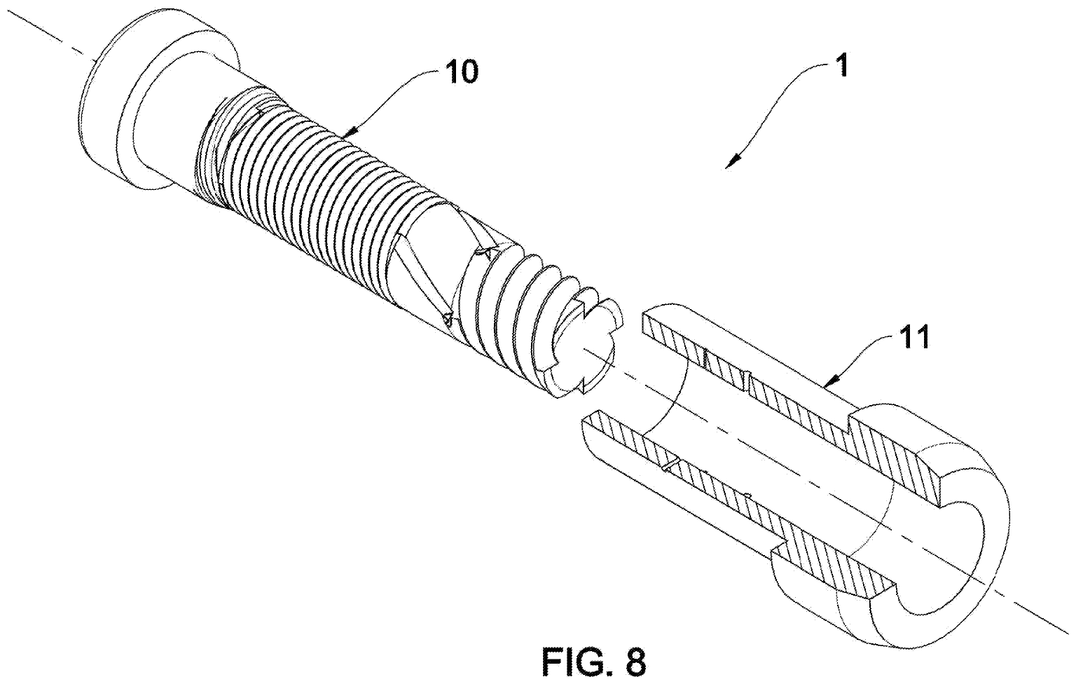

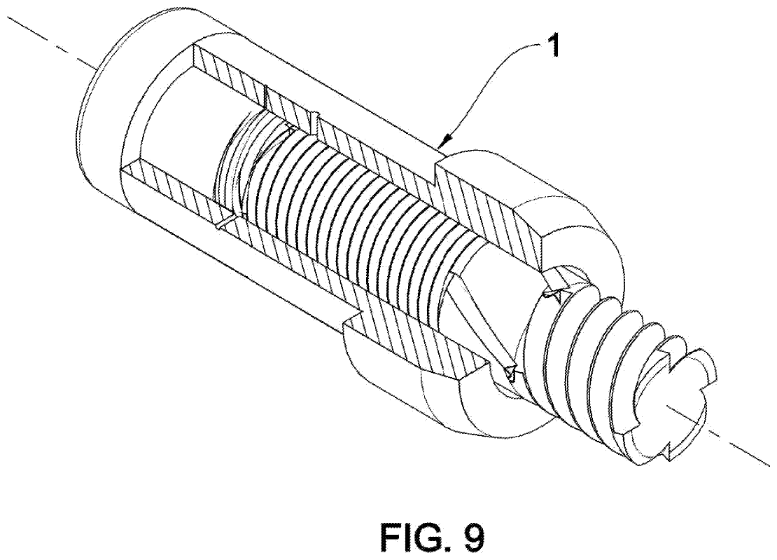

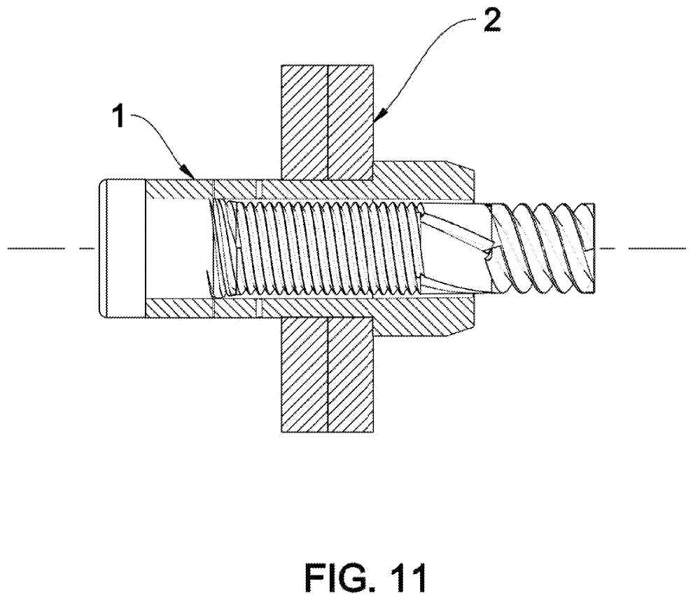

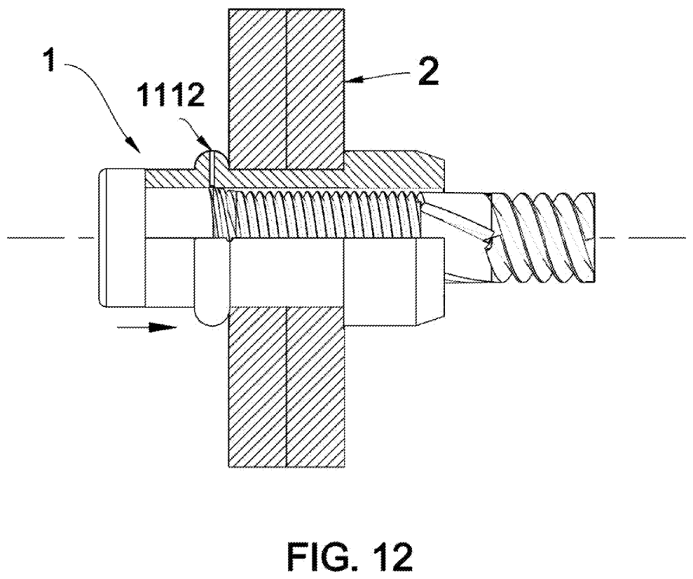

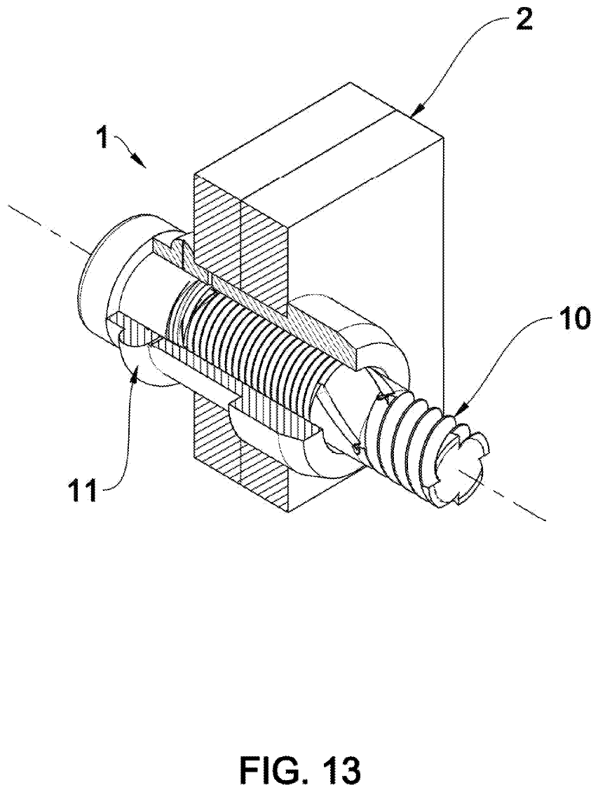

Referring to FIGS. 3 to 13, a threaded fastener 1 in accordance with a first preferred embodiment of the invention comprises a bolt 10 including an enlarged head 100 and a threaded shank 101 including a bare section 1010 proximate the head 100, a threaded end section 1013, an intermediate section 1012 proximate the threaded end section 1013 and having a spiral trough 10120, and a threaded section 1011 between the intermediate section 1012 and the bare section 1010.

The threaded fastener 1 further comprises a hollow member 11 including an enlarged head 110 and a malleable shank 111 having a plurality of first holes 1110, second holes 1111, and third holes 1112.

This arrangement can increase a fastening force, decrease length, and decrease manufacturing cost of the threaded fastener 1.

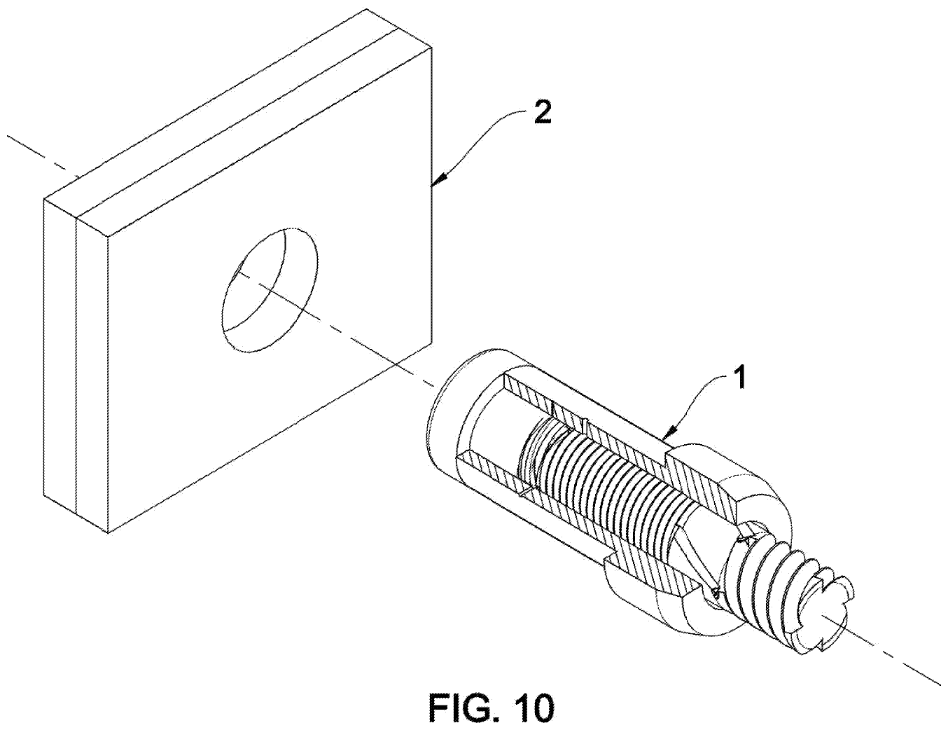

In a fastening step (see FIGS. 10 to 13), the hollow member 11 is inserted through a hole 20 of a work piece 2 until the head 110 contacts a front surface of the work piece 2. Next, the bolt 10 is inserted through the hollow member 11 to press the malleable shank 111. Thus, a portion of the malleable shank 111 adjacent the third holes 1112 is raised to urge against a rear surface of the work piece 2. As a result, the work piece 2 is fastened by the threaded fastener 1. It is noted that the provision of the first holes 1110, second holes 1111, and third holes 1112 facilitates the malleability of the shank 111.

The invention has the following advantages and benefits in comparison with the conventional art: length of the bolt 10 is decreased. A variety of work pieces 2 having different thickness can be fastened.

While the invention has been described in terms of preferred embodiments, those skilled in the art will recognize that the invention can be practiced with modifications within the spirit and scope of the appended claims.

What is claimed is:

1. A fastener, comprising:
a bolt including a head and a threaded shank including a bare section proximate the head, a threaded end section, an intermediate section proximate the threaded end section and having a spiral trough, and a threaded section between the intermediate section and the bare section; and
a hollow member including a head member and a malleable shank having a plurality of holes.
